(19) United States
(12) Patent Application Publication
(10) Pub. No.: US 2012/0116734 A1
(43) Pub. Date: May 10, 2012

(54) Method of characterizing an electrical defect affecting an electronic circuit, related device and information recording medium

(75) Inventors: Fulvio INFANTE, Toulouse (FR); Philippe PERDU, Toulouse (FR)

(73) Assignee: CENTRE NATIONAL D'ETUDES SPATIALES, Paris (FR)

(21) Appl. No.: 13/270,064

(22) Filed: Oct. 10, 2011

(30) Foreign Application Priority Data
Oct. 11, 2010 (FR) 10 58224

(51) Int. Cl. G06F 17/50; G06F 17/14

(52) U.S. Cl. 703/2

(57) ABSTRACT

The method according to the invention consists of producing a real cartography of the magnetic field radiated by the circuit placed in a predetermined operating state. It includes the following steps: a) applying a transform to an initial hypothesis on the nature of the defect, to obtain a current hypothesis, b) superimposing the current hypothesis on an initial topology of the circuit to obtain a current topology; c) simulating the magnetic field generated by the current topology, so as to obtain a current simulated cartography; d) estimating the current value of a correlation function between the measured cartography and the current simulated cartography; and e) iterating steps a) to d) to seek a maximum of the correlation function by modifying the value of said characteristic parameter of the defect.

The invention relates to the field of methods for characterizing electrical defects affecting an electronic circuit, as well as devices for implementing such methods.

Defect analysis is an important step in the development phase of electronic circuits, in particular electronic circuits intended to be incorporated into a package. In fact, when a circuit is identified as defective, it is crucial to determine the cause so as to take suitable corrective measures so that that defect does not affect circuits to be produced in the future.

When the electrical defect is of the short circuit type between two conductive tracks of the circuit or a discontinuity in the conductivity along a conductive track of the circuit, one of the questions the defect analysis must answer is the location of that defect, and more generally the characterization of the defect.

One known defect location technique is the MCI (Magnetic Current Imaging) technique. This technique makes it possible to produce a cartography of the currents circulating in a circuit.

Using an extremely sensitive probe (for example of the SQUID type), the component along one direction, for example direction Z, of the magnetic field radiated by the circuit positioned in a plane XY, is measured at different points of a reference surface.

This involves reversing the cartography of the magnetic field thus obtained, using reverse Fourier transforms, so as to obtain a cartography of the sources of the measured magnetic field, i.e. the currents circulating in the circuit.

Then, by comparing the cartography of the currents obtained from the defective circuit and a cartography of the currents obtained from a circuit that is known to be operating correctly, it is possible to locate the defect affecting the tested defective circuit.

The theoretical resolution of the MCI technique is about half the size of the probe used, 15 μm in the example of a SQUID probe.

The MCI technique is greatly limited by the distance between a source of the magnetic field and the probe. In practice, sources situated more than 5 to 6 mm from the probe cannot be detected in isolation and contribute to measurement uncertainty.

Another problem arises from the fact that the MCI technique only measures the component in direction Z of the magnetic field. The components in directions X and Y are not measured. As a result, the currents circulating in direction Z, i.e. in the thickness of the circuit, and that make no contribution to the component in direction Z of the magnetic field, cannot be detected. These currents therefore cannot be identified using the MCI technique.

Lastly, the MCI technique models the currents circulating in the circuit through current distributions circulating in plane XY of the circuit. The MCI technique is thus specific to defect location in two-dimensional (2D) circuits.

However, a new generation of 3D circuits, made by stacking chips, has arrived on the market. In these 3D circuits, a ground plane may be provided.

In the case of a short circuit with the ground plane, however, the short circuit current first flows substantially in the thickness of the circuit to rejoin the ground plane, and, once in the ground plane, then flows diffusely through the ground plane toward an output tongue.

The MCI technique therefore cannot detect the short circuit current when it flows toward the ground plane or when it flows into the ground plane: in the first case it flows in direction Z (thickness of the circuit); in the second case, its intensity is too weak and it is too far from the probe for the magnetic field it generates to be analyzable using that technique.

As a result, for these 3D circuits, one returns to analysis techniques destroying the defective circuit, which consist of deconditioning it. These techniques do not yield good results, since, quite often, when the circuit is destroyed, the defect one wishes to characterize is altered.

The invention therefore aims to respond to the aforementioned problems by proposing a non-destructive defect location method that is faster to implement and more precise than the known techniques, and which advantageously makes it possible to take the currents circulating in the thickness of the circuit and those circulating in the ground plane of the circuit into account.

To that end, the invention relates to a method for characterizing an electrical defect affecting an electronic circuit, consisting of producing a real cartography C_0 of the magnetic field by measuring, using a probe, at different points around the circuit, at least one component of the magnetic field radiated by the circuit placed in a predetermined operating state, characterized in that it includes the following steps:

a) applying a transform T_j to an initial hypothesis on the nature of the defect, to obtain a current hypothesis Hyp_i, the transform being able to modify the value of a characteristic parameter of the defect;

b) superimposing the current hypothesis on an initial topology S_0 of the circuit to obtain a current topology S_i;

c) simulating, at different predetermined points, said at least one component of the magnetic field generated by the current topology, so as to obtain a current simulated cartography C_i;

d) estimating the current value Corr_i of a correlation function between the measured cartography and the current simulated cartography; and

e) iterating steps a) to d) to seek a maximum of the correlation function by modifying the value of said characteristic parameter of the defect, the value of the characteristic parameter corresponding to said maximum making it possible to determine, with the initial hypothesis on the nature of the defect, a value of said parameter of the actual defect.

According to specific embodiments, the method includes one or more of the following features, considered alone or according to all technically possible combinations:
the method includes an initial step for configuring an initial hypothesis Hyp_0 consisting of choosing a type of elementary defect and defining the initial value of at least one parameter of the defect.
the type of elementary defect is chosen from among the segment and resistor array types.
the elementary defect being of the resistor array type, the array including nodes and meshes, each mesh bearing an elementary resistor, the transform is chosen among the transforms affecting the node of the array on which the current of the defect is injected, the transforms affecting the node of the array by which the current leaves the defect, and the transforms pertaining to the intensity of the current of the defect.
the step for simulating the magnetic field includes an initial step consisting of determining the value of the currents circulating in each of the meshes of the resistor array.
the method includes a prior step for choosing the initial topology S_0 and in that the selected initial topology S_0 is a final topology resulting from the application of the preceding method by using a first transform able to modify a first parameter of the defect.
the iteration of step a) consists of applying a so-called elementary transform to a hypothesis formulated in the preceding iteration to obtain the hypothesis formulated in the current iteration, an elementary transform being able to cause the characteristic parameter of the defect to vary by a predetermined quantity, and step e) consists, upon each iteration of step d), of testing the current value of the correlation function:

if said current value is greater than the value of the correlation function in the preceding iteration, retaining, for the following iteration, the hypothesis formulated in the current iteration as hypothesis formulated in the preceding iteration;

otherwise, not retaining the hypothesis formulated in the current iteration and selecting, for the following iteration, a subsequent elementary transform in an ordered group of elementary transforms, until the entire ordered group of elementary transforms has been passed through.
The method is implemented several times with different orientations of the defective circuit relative to a plane perpendicular to the component of the magnetic field measured by the probe.

According to specific embodiments, the device for implementing the preceding method, including a test bed for producing a real cartography C_0 of the magnetic field radiated by the circuit placed in a predetermined operating state, characterized in that it also includes:
a means for applying a transform T_j to a hypothesis on the nature of a defect, to obtain a current hypothesis Hyp_i, the transform being able to modify the value of a characteristic parameter of the defect;
a means for superimposing the current hypothesis on an initial topology of the circuit S_0, to obtain a current topology S_i;
a means for simulating the amplitude of said at least one component of the magnetic field generated by the current topology, to obtain a current simulated cartography C_i;
a correlation means able to determine the current value Corr_i of a correlation function between the measured cartography and the current simulated cartography; and
a means for seeking a maximum of the correlation function for different values of the characteristic parameter of the defect.

According to specific embodiments, the device includes one or more of the following features, considered alone or according to all technically possible combinations:
the transform being an elementary transform, the means for seeking a maximum includes:
a means for comparing the current value with the value in the preceding iteration Corr_i−1 of the correlation function;
a means for assigning the hypothesis formulated in the current iteration as hypothesis formulated in the preceding iteration.
   The device includes a means for selecting the transform to be applied in an ordered group of transformations.

The invention also relates to an information recording medium, characterized in that it includes instructions for carrying out the method for locating an electrical defect in a defective circuit as described above, when the instructions are carried out by an electronic computer.

Other features and advantages of the invention will emerge more clearly from the following detailed description, provided for information and non-limitingly, done in reference to the appended drawings, in which:

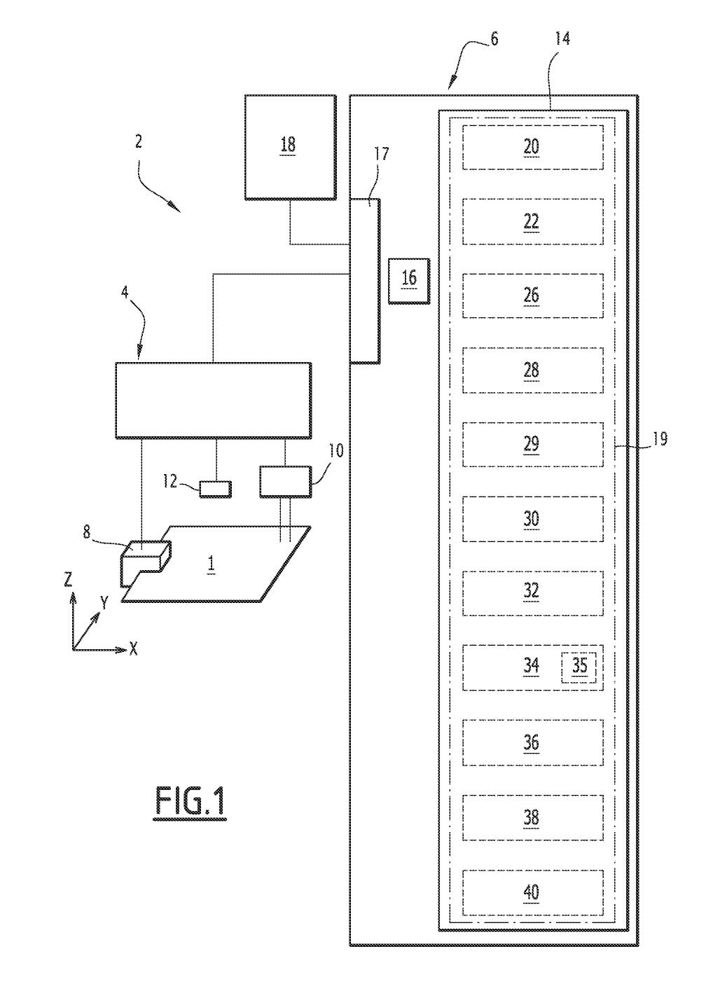

FIG. 1 is a diagrammatic illustration of the device according to the invention;

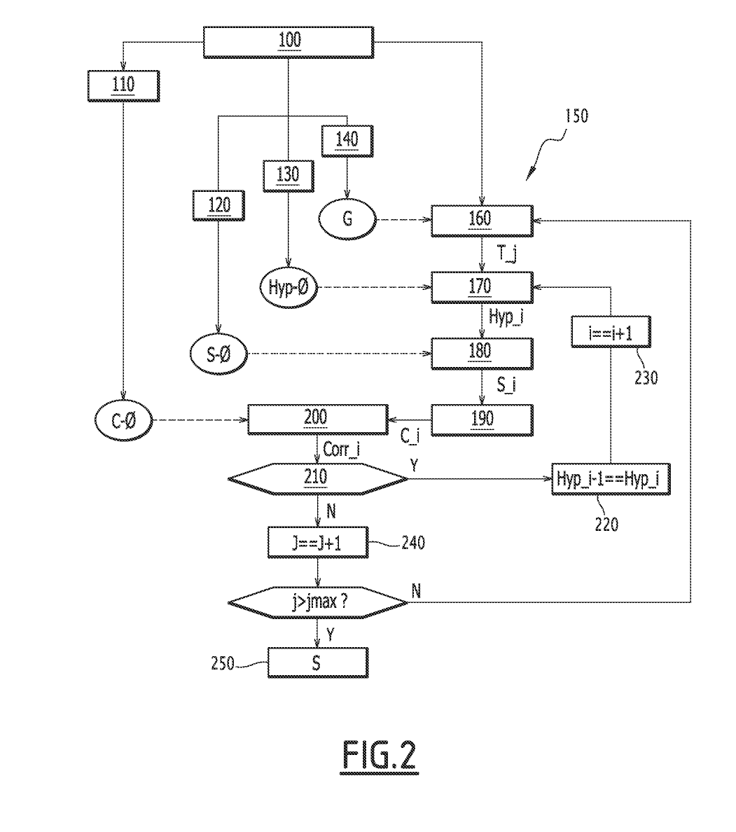

FIG. 2 is a flowchart showing the method according to the invention; and

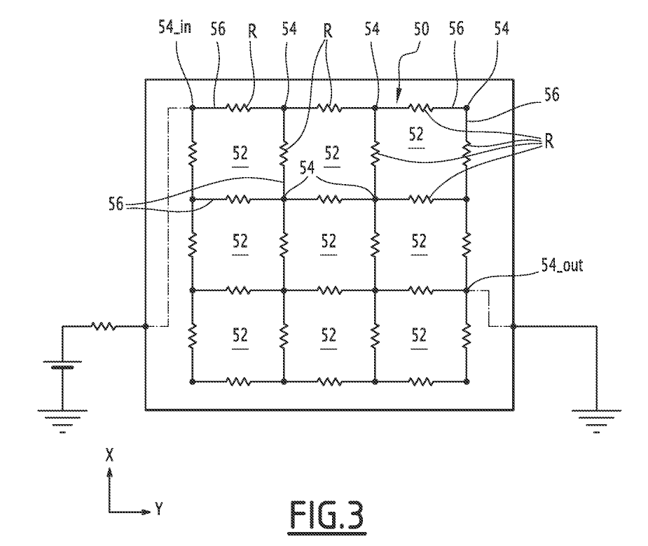

FIG. 3 is an illustration of an elementary defect of the array type used to formulate an initial hypothesis during implementation of the method of FIG. 2.

Diagrammatically illustrated in FIG. 1 is a device for implementing the method for locating a defect in a defective electrical circuit.

To locate a defect on the circuit 1, the device 2 includes a test bed 4 coupled to a computer 6.

The test bed 4 includes a support means 8 for the circuit 1, a means 10 for supplying the circuit 1 with electrical current, and a probe 12 for measuring a component of the magnetic field.

The probe 12 is preferably a probe of the SQUID type having great sensitivity.

The support means 8 can be controlled to modify the relative position and orientation of the circuit 1 in relation to the probe 12.

The supply means 10 can be controlled to supply an electrical current adapted so as to place the circuit 1 in a particular desired operating state during the test.

The computer 6 includes a storage means 14, such as a random access memory and a read-only memory, able to store the values of variables or parameters, as well as computer program instructions.

The computer 6 includes a computation means 16, such as a microprocessor, able to carry out the instructions of programs stored in the storage means 14.

The computer 6 also includes an input/output interface 17 allowing the computer 6 to communicate with peripherals, such as the test bed 4 and a man/machine interface means 18 (monitor, keyboard, etc.) of the computer 6.

Among the various computer programs stored in the storage means 14, the computer 6 includes application software 19 whereof the instructions, once run by the computation means 16, make it possible to implement the method for locating a defect described below. The program 19 is diagrammed by the different modules it includes, shown by broken lines in FIG. 1.

The program 19 includes a module for producing an actual cartography 20, a module for defining an initial topology 22, a module 26 for developing an initial hypothesis, a module for defining a group of elementary transforms 28, a selection module 29, a transform module 30, a superposition module 32, a simulation module 34, a correlation module 36, a comparison module 38, and an allocation module 40.

The module for producing an actual cartography 20. This module makes it possible to control the test bed so as to obtain an actual cartography C_0 of the magnetic field radiated by the circuit 1.

A cartography associates the values of at least one component of the magnetic field in a series of predetermined points relative to the circuit 1. For the actual cartography, these values are the measurements done by the probe 12. Preferably, the series of points belongs to a planar reference surface, parallel to the plane of a substrate of the circuit 1.

The actual cartography C_0 obtained by the module 20 is stored in the storage means 14.

The module for defining an initial topology 22. The module 22 makes it possible to display an adapted window on the monitor of the computer 6 so that the user can define a topology that will be taken into account as the initial topology S_0.

In the rest of this document, topology refers to a distribution of the current density circulating in the circuit. This involves not only the geometry of the tracks of the circuit, but also the intensity of the currents circulating along each of those tracks when the circuit is in a particular operating state.

The initial topology S_0, defined by the user through the interface of the module 22, is stored in the storage means 14.

A module for developing an initial hypothesis 26. The module 26 makes it possible to formulate an initial hypothesis Hyp_0 on the nature of an elementary defect affecting the circuit.

The module 26 makes it possible to display an adapted window on the monitor of the computer so that the user can choose the type of elementary defect from among the list of elementary defects, then define the different parameters characterizing that defect.

A first type of elementary defect is a linear short circuit current, modeled by a segment having an initial length, passed through by an initial intensity current. For a segment, the user defines the position in X, Y, and Z of the center of the segment, the orientation in θ and φ of the segment, the initial length of the segment, and the initial intensity passing through the segment. These parameters are stored, as initial hypothesis, in the storage means 14.

A second type of elementary defect is a current circulating in a ground plane, modeled by a resistor array. This type of elementary defect will be described in more detail below in reference to FIG. 3.

The module for defining a group of elementary transforms 28.

An elementary transform is a transform to be applied to an elementary defect so that it better corresponds to the actual defect affecting the circuit. A transform depends on the type of elementary defect chosen for the initial hypothesis. The elementary transforms that the user can select for an elementary defect of the segment type for example include the translations, rotations, elongations, variations of the intensity passing through the segments, etc. They are in fact all of the possible transforms on the parameters defining the elementary defect of the initial hypothesis.

The module 28 can have an adapted window on the monitor of the computer so that the user can define a group G by selecting one or more possible elementary transforms presented to him, and ordering the selected transforms using an integer identifier (j in the following).

The group G thus defined is stored in the storage means 14.

The selection module 29 is able to select a transform in the group G as a function of the current value of the integer j.

The transform module 30 is able to apply the elementary transform selected by the module 29 to the value of a variable called “hypothesis formulated in a preceding iteration” (Hyp_i−1), to obtain the value of the variable called “hypothesis formulated in a current iteration” (Hyp_1). During the first iteration, the hypothesis formulated in the preceding iteration is the initial hypothesis that the module 30 is able to read in the storage means.

The superposition module 32 is able to add, to the initial topology of the circuits S_0, the hypothesis formulated in the current iteration (Hyp_i) obtained at the output of the module 30, so as to obtain a current hypothetical topology (S_i).

The simulation module 34 is able, from the current hypothetical topology (S_i) obtained at the output of the module 32, to simulate a cartography of the magnetic field generated by the current hypothetical topology (C_i).

The obtained simulated cartography associates, for each of the predetermined points used in producing the actual cartography C_0, the value of the component of the magnetic field at that point, the component of the magnetic field being that measured by the sensor 12.

The cartography simulated in the current iteration C_i is saved in the storage means.

The module 34 includes a sub-module 35 for determining the currents circulating on the meshes of a resistor array. The use of this sub-module 35 will be described below in reference to FIG. 3.

The correlation module 36 is able to determine the value of a correlation function between the actual cartography C_0 at the output of the module 20 and the current simulated cartography C_i at the output of the module 34. The current value of the correlation function Corr_i is stored.

The comparison module 38 is able to determine whether the current value Corr_i of the correlation function is greater than or equal to the value in the preceding iteration of the correlation function Corr_i−1. The output of the module 38 is a binary variable assuming the value 0 (false), or value 1 (true).

An allocation module 40 able to allocate the value of the variable “hypothesis formulated in the current iteration” to the variable “hypothesis formulated in the preceding iteration.”

The method for locating a defect in the defective circuit 1 will now be described in reference to FIG. 2 through a first example relative to a defect of the segment type.

When a circuit 1 has been identified as defective, it is placed on the test bed 4 (step 100).

In step 110, owing to the execution of the module 20, an actual cartography C_0 is produced.

More specifically, by actuating the support means 8, the defective circuit 1 is for example positioned in the referential of the test bed 4 so that the plane of a substrate of the circuit corresponds to plane XY, and the thickness of the circuit corresponds to the direction Z of the reference of the test bed. A characteristic point of the circuit, such as a corner of the substrate, is initially placed at the origin of the reference of the test bed.

Owing to the supply means 10, the circuit 1 is supplied with electrical current so as to place it in a predetermined operating state.

The cartography of the magnetic field radiated by the defective circuit is then done.

To that end, the probe 12 acquires a measurement of the component 2 of the magnetic field for a series of points. This series of points is preferably situated on a reference surface, for example rectangular and planar, parallel to the plane XY, and situated at a distance from the circuit 1. The distance separating the reference surface from the circuit is between 1 mm and 10 mm.

The actual cartography obtained C_0 is saved in the memory of the computer 6.

In step 120, the user then defines the initial topology S_0 using the interface of the module 22. The initial topology S_0 is for example the topology of a circuit operating correctly.

In step 130, the user defines the initial hypothesis Hyp_0 using the interface of the module 26. The initial hypothesis consists of choosing the defect of the segment type and filling in the parameters for that elementary defect: segment 1 mm long, passed through by a current of 1 mA, at the geometric center of the circuit, so that said segment is aligned with direction X (θ=0 and φ=π/2).

Lastly, in step 140, the user defines the group G of elementary transforms to be used, using the interface of the module 28. An ordered group G is for example as follows:

j=1: elementary translation of the defect on a predetermined pitch toward the X positives;
j=2: elementary translation of the defect on a predetermined pitch toward the X negatives;
j=3: elementary translation of the defect on a predetermined pitch toward the Y positives;
j=4: elementary translation of the defect on a predetermined pitch toward the Y negatives;
j=5: elementary translation of the defect on a predetermined pitch toward the Z negatives;
j=6: elementary translation of the defect on a predetermined pitch toward the Z negatives;
j=7: elementary transform by rotation of the defect by a positive predetermined angle in θ;
j=8: elementary transform by rotation of the defect by a negative predetermined angle in θ,
j=9: elementary transform by rotation of the defect by a positive predetermined angle in φ,
j=10: elementary transform by rotation of the defect by a negative predetermined angle in φ,
j=11: elementary transform by stretching a predetermined length of the length of the defect;
j=12: elementary transform by reducing a predetermined length of the length of the defect;
j=13: elementary translation by increasing a predetermined variation of the intensity of the current circulating in the defect;
j=14: transform by decreasing a predetermined variation of the intensity of the current circulating in the defect.

This different configuration data is placed in the memory of the computer 6.

After this configuration phase, the user launches the execution of the algorithm 150 shown diagrammatically in FIG. 2.

The real variable Corr_0 and the integer variables i and j are respectively initialized at values 0, 1, and 1.

In step 160, in the first iteration of the algorithm, the transform T_1 is selected in the group G, by the selection module 29.

Then, in step 170, the execution of the transform module 30 allows the application of the transform T_1 to the initial hypothesis Hyp_0 to obtain the current hypothesis of the first iteration Hyp_1.

In step 180, the execution of the superposition module 32 makes it possible to superimpose, on the initial topology S_0, the current hypothesis Hyp_1, so as to obtain the current topology of the first iteration S_1.

In step 190, using the module 34, the computer 6 calculates the magnetic field radiated by the current topology S_1 at the reference surface, i.e. each of the points of the series of points used to produce the actual cartography. Since the modeling of the physical problem is done using linear distributions, the Biot-Savart law and the superposition principle allow simple and fast calculations. A simulated cartography C_1 is obtained and stored.

Then, in step 200, the execution of the module 36 makes it possible to compare the simulated cartography with the real cartography. The possible correlation function may for example be a correlation function used in statistics and known by those skilled in the art.

A value of the correlation for this first iteration Corr_1 is determined.

In step 210, the comparison module 38 is executed to determine whether the current value of the correlation function Corr_1 is greater than or equal to the preceding value of the correlation function Corr_0 for the first iteration.

Since the value of Corr_0 initially received the zero value, the value of the correlation function Corr_1 must be greater than that zero value. The binary value output from the module 38 is therefore positive.

As a result, the current hypothesis Hyp_1 is allocated to the preceding hypothesis, and a new iteration of the algorithm is done by incrementing the integer i (i=i+1).

For the i^{th} iteration, the value of j still being equal to 1, the transform T_1 is selected in the group G (step 160).

Then, the execution of the module 30 makes it possible to apply the transform T_1 to the hypothesis formulated in the preceding iteration Hyp_i−1 to obtain the hypothesis formulated in the current iteration Hyp_i (step 170).

Then, the execution of the module 32 makes it possible to superimpose, on the initial topology S_0, the hypothesis formulated in the current iteration Hyp_i, so as to obtain a current topology S_i (step 1).

Once the current topology S_i is developed, the computer calculates the magnetic field radiated by that topology at the reference surface. A current simulated cartography C_i is obtained at the end of execution of the module 34 (step 190).

Then, in step 200, the computer executes the module 36 to compare the current simulated cartography C_i with the real cartography C_0. A current value Corr_i of the correlation for iteration i is determined.

In step 210, the comparison module 38 is executed to test the current value Corr_i relative to the preceding value Corr_i−1 of the correlation function.
If the value of the current correlation Corr_i is greater than the value of the preceding correlation Corr_i−1, this means that the transform of the preceding hypothesis makes it possible to come closer to the actual topology of the defective circuit. Under these conditions, the elementary transform T_1 is kept and will be applied during the following iteration of the algorithm. In step 220, the value of the current hypothesis Hyp_i is allocated as preceding hypothesis Hyp_i−1 for the following iteration. A new iteration of the algorithm 150 is then started after having incremented the integer i by one unit (step 230).
If the value of the current correlation Corr_i is less than the value of the preceding correlation Corr_i−1, this means that the transform applied to the preceding hypothesis leads to a topology moving away from the actual topology of the defective circuit. The current hypothesis Hyp_i is not retained, and the integer j is incremented by one unit (step 240). In this way, in the following iteration of the algorithm 150, the following transform in the group G will be selected by the module 30 and will be applied to the preceding hypothesis Hyp_i, the value of which has not changed.

A same elementary transform T_j is used so as to obtain a relative maximum of the correlation function. Then, once this relative maximum is reached, the following transform T_j+1 is used so as to look for a new maximum greater than the previous one.

The entire group G is thus passed through and the execution of the algorithm ends when the number j_max) of elementary transforms making up the group G.

The last current hypothetical topology is kept as final topology S (step 250).

The algorithm converges toward a final topology S that corresponds to a correlation maximum with the real cartography. This final topology is considered to be the real topology of the defective circuit. It gives the location (position, orientation, length, intensity) of the defect affecting the circuit 1.

In a first alternative embodiment, the final topology S can be used as initial topology S_0 for a new execution of the algorithm 150 so as to add a second elementary defect. This makes it possible to locate several defects in the same circuit or a single defect having a complex shape, comparable to several segments with different orientations, positioned end to end.

More generally, it is possible, owing to this method and using the hypothesis of linear current distribution, to reconstruct the entire actual circuit, i.e. both the current lines corresponding to the tracks of the circuit, and the current lines corresponding to defects affecting the circuit.

In a second alternative embodiment, independent from the previous one, the final topology S obtained after a first execution of the algorithm 150 with a first transform group is used as initial topology S_0 for a second execution of the algorithm 150, but with the second group of elementary transforms. For example, the first group of transforms is characterized by significant translational and/or rotational pitches, while the second group of transforms is characterized by smaller translational and/or rotational pitches. In this way, the first execution of the algorithm makes it possible to obtain a quick, but imprecise location of the defect, while the second execution of the algorithm, using the final topology of the first execution, makes it possible to obtain a precise location of the defect.

In a third alternative, the user develops a strategy so that the algorithm 150 converges more quickly. For example, the user, after observing the real cartography C_0, can decide, during formulation of the initial hypothesis, to position the elementary defect in the area of the circuit where he thinks the defect is located. He can also order the elementary transforms within the group G for that same purpose.

Advantageously, the entire method is implemented several times, successively. Between two implementations, the support means 8 are actuated so as to incline the circuit 1 by a given angle relative to the plane XY. In this way, a defect leading to the flow of a current into the thickness of the circuit 1 generates a contribution to the component of the magnetic field measured by the probe 12. The defects in the three dimensions of the circuit can thus be located.

A second implementation of the method will now be described. This second example illustrates how to locate a defect of the short circuit type with the ground plane of the circuit.

The location of such a defect is based on the modeling of the ground plane by a resistor array.

The module 26 makes it possible to define an initial hypothesis by selecting an elementary defect of the “resistor array” type.

Such an array is for example the square mesh array of FIG. 3. The array 50 includes nodes 54 and meshes 56, connected to one another at the nodes 54. Each mesh 56 bears an elementary resistor R, the value of which is identical from one mesh to the next.

The parameters that the user must define when selecting this type of elementary defect are the number of meshes of the array and the value of the elementary resistance R, as well as the node of the array 54_in through which the current is injected into the array, the node of the array 54_out through which the current leaves the array, and the value of the total intensity of the current circulating in the array.

The module 28 has a plurality of elementary transforms adapted to defects of the “resistor array” type. These elementary transforms are for example:
the increase of the intensity of the current circulating in the array by a predetermined variation;
the decrease of the intensity of the current circulating in the array by a predetermined variation;
the translation of a node in direction X of the input node of the current;
the translation of a node in direction Y of the input node of the current;
the translation of a node in direction X of the output node of the current;
the translation of a node in direction Y of the output node of the current.

Using the module 22, the user fills in the initial topology S_0.

Then, the algorithm 150 is executed.

The module 32 superimposes, on the initial topology S_0, the current hypothesis Hyp_i that the resistor array has, so as to obtain a current topology S_i.

The execution of the simulation module 34 begins by calling on the sub-module 35, the purpose of which is to determine the intensity of the currents circulating in each of the meshes of the array 50. To that end, the sub-module 35 uses the laws relative to the resistor arrays that make it possible to determine the intensities of the currents circulating in each of the meshes from the number of meshes, the shape of the mesh, and the value of the elementary resistor R.

Once this computation is done, the module 34 determines the total magnetic field created by the current topology S_i. In particular, each mesh being considered a segment pertaining to a linear current distribution whereof the value has been determined by the sub-module 35, the use of the Biot-Savert law and the superposition principle ensures a rapid simulation of the magnetic field generated by the resistor array in the other elements of the current topology S_i.

Then, the correlation module 36 determines the degree of similarity between the simulated cartography and the real cartography.

In the following iteration, the elementary transforms selected by the module 180 in the group G is applied to the current hypothesis Hyp_i. For example, the hypothesis is modified by moving the input node of the current 54_in of a mesh to the right.

Following this transform of the hypothesis, steps 180 to 200 are iterated.

If the correlation between the simulated cartography and the real cartography increases, the current transform is kept and applied again during the following iteration.

If, on the contrary, the correlation between the simulated cartography and the real cartography increases, the current transform, the following transform in the group G is selected for the following iteration of the algorithm 150.

This continues until all transforms of the group G have been considered. The current hypothesis of the last iteration, which yields a correlation maximum with the real cartography, makes it possible to locate a short circuit with the ground plane.

In one alternative embodiment of the method, one first starts with a set of values of the characteristic parameter of the defect, associated with a same transform. For example, for the translation transform in direction X, the set of values is made up of approximately ten different X axis values for the positioning point of the defect of the segment type. Then, for each value of the characteristic parameter, a cartography is simulated and the corresponding correlation function is calculated. Lastly, an interpolation, for example polynomial, is done for the different obtained values of the correlation function. The maximum of the interpolation function makes it possible to determine the optimal value of the characteristic parameter of the defect, in our example the position in direction X thereof.

The algorithm for implementing the method makes it possible to obtain precise results (approximately 1 μm for a probe/circuit distance substantially equal to that used in the MCI technique), extremely quickly. This is due to the fact that the method works directly on the sources of the magnetic fields, and that furthermore, it uses the hypothesis of linear distribution currents.

1. A method for characterizing an electrical defect affecting an electronic circuit, consisting of producing a real cartography of the magnetic field by measuring, using a probe, at different points around the circuit, at least one component of the magnetic field radiated by the circuit placed in a predetermined operating state, wherein the method includes the following steps:
a) applying a transform to an initial hypothesis on the nature of the defect, to obtain a current hypothesis, the transform being able to modify the value of a characteristic parameter of the defect;
b) superimposing the current hypothesis on an initial topology of the circuit to obtain a current topology;
c) simulating, at different predetermined points, said at least one component of the magnetic field generated by the current topology, so as to obtain a current simulated cartography;
d) estimating the current value of a correlation function between the measured cartography and the current simulated cartography; and
e) iterating steps a) to d) to seek a maximum of the correlation function by modifying the value of said characteristic parameter of the defect, the value of the characteristic parameter corresponding to said maximum making it possible to determine, with the initial hypothesis on the nature of the defect, a value of said parameter of the actual defect.

2. The method according to claim 1, wherein the method includes an initial step for configuring an initial hypothesis consisting of choosing a type of elementary defect and defining the initial value of at least one parameter of the defect.

3. The method according to claim 2, wherein the type of elementary defect is chosen from among the segment and resistor array types.

4. The method according to claim 3, wherein, when the elementary defect is of the resistor array type, the array including nodes and meshes, each mesh bearing an elementary resistor, the transform is chosen among the transforms affecting the node of the array on which the current of the defect is injected, the transforms affecting the node of the array by which the current leaves the defect, and the transforms pertaining to the intensity of the current of the defect.

5. The method according to claim 4, wherein the step for simulating the magnetic field includes an initial step consisting of determining the value of the currents circulating in each of the meshes of the resistor array.

6. The method according to claim 1, wherein the method includes a prior step for choosing the initial topology and in that the selected initial topology is a final topology resulting from the application according to claim 1 by using a first transform able to modify a first parameter of the defect.

7. The method according to claim 1, wherein the iteration of step a) consists of applying a so-called elementary transform to a hypothesis formulated in the preceding iteration to obtain the hypothesis formulated in the current iteration, an elementary transform being able to cause the characteristic parameter of the defect to vary by a predetermined quantity,
and in that step e) consists, upon each iteration of step d), of testing the current value of the correlation function:
if said current value is greater than the value of the correlation function in the preceding iteration, retaining, for the following iteration, the hypothesis formulated in the current iteration as hypothesis formulated in the preceding iteration;
otherwise, not retaining the hypothesis formulated in the current iteration and selecting, for the following iteration, a subsequent elementary transform in an ordered group of elementary transforms, until the entire ordered group of elementary transforms has been passed through.

8. The method according to claim 1, wherein the method is implemented several times with different orientations of the defective circuit relative to a plane perpendicular to the component of the magnetic field measured by the probe.

9. A device for implementing the method for characterizing an electrical defect affecting an electronic circuit according to claim 1, including a test bed for producing a real cartography of the magnetic field radiated by the circuit placed in a predetermined operating state, wherein the device also includes:
a means for applying a transform to a hypothesis on the nature of a defect, to obtain a current hypothesis, the transform being able to modify the value of a characteristic parameter of the defect;
a means for superimposing the current hypothesis on an initial topology of the circuit, to obtain a current topology;
a means for simulating the amplitude of said at least one component of the magnetic field generated by the current topology, to obtain a current simulated cartography;
a correlation means able to determine the current value of a correlation function between the measured cartography and the current simulated cartography; and
a means for seeking a maximum of the correlation function for different values of the characteristic parameter of the defect.

10. The device according to claim 9, wherein, the transform being an elementary transform, the means for seeking a maximum includes:
a means for comparing the current value with the value in the preceding iteration of the correlation function;
a means for assigning the hypothesis formulated in the current iteration as hypothesis formulated in the preceding iteration.

11. The device according to claim 10, wherein it includes a means for selecting the transform to be applied in an ordered group of transformations.

12. An information recording medium, wherein it includes instructions for carrying out the method for locating an electrical defect in a defective circuit according to claim 1, when the instructions are carried out by an electronic computer.
